(19) United States
(12) Patent Application Publication
(10) Pub. No.: US 2013/0009911 A1
(43) Pub. Date: Jan. 10, 2013

(54) UNDERLAY-BOARD-EQUIPPED INPUT DEVICE

(75) Inventors: Naoki Shibata, Osaka (JP); Emiko Tani, Osaka (JP); Toshiki Naito, Osaka (JP); Yusuke Shimizu, Osaka (JP)

(73) Assignee: NITTO DENKO CORPORATION, Osaka (JP)

(21) Appl. No.: 13/537,188

(22) Filed: Jun. 29, 2012

Related U.S. Application Data
(60) Provisional application No. 61/514,682, filed on Aug. 3, 2011.

(30) Foreign Application Priority Data
Jul. 4, 2011 (JP) 2011-148181
Apr. 19, 2012 (JP) 2012-096014

(51) Int. Cl. G06F 3/042

(52) U.S. Cl. 345/175

(57) ABSTRACT

An underlay-board-equipped input device is provided which is capable of preventing positional displacement of a writing paper sheet when a user is writing on the set writing paper sheet and when the writing paper sheet is set again. An underlay board is mounted to the back surface of a rectangular frame-shaped input device having a rectangular hollow input-use interior pivotably about one end edge of the input device. The input device includes a rectangular frame-shaped optical waveguide having the hollow input-use interior. A means for positioning a writing paper sheet (such as protrusions) is provided on the front surface of the underlay board. The front surface of the underlay board and the back surface of the input device are configured to form a holding part for holding the writing paper sheet therebetween.

### RELATED APPLICATIONS

This application claims the benefit of U.S. Provisional Application No. 61/514,682 filed on Aug. 3, 2011, which is hereby incorporated by reference.

### FIELD OF THE INVENTION

The present invention relates to an underlay-board-equipped input device including an optical position detection means.

### BACKGROUND OF THE INVENTION

Conventionally, an optical position detection device (see Japanese Patent No. 3682109, for example) including a plurality of light-emitting elements and a plurality of light-receiving elements is proposed as an input device. This optical position detection device is in the form of a rectangular frame comprised of a pair of L-shaped sections. The light-emitting elements are disposed in juxtaposition in one of the L-shaped sections of the rectangular frame, and the light-receiving elements opposed to the aforementioned light-emitting elements are disposed in juxtaposition in the other L-shaped section thereof. The rectangular frame-shaped optical position detection device is placed along the periphery of a rectangular display. Information such as a character is inputted to the optical position detection device and is caused to appear on the aforementioned display by moving a pen, a finger and the like within the rectangular frame of the optical position detection device. Specifically, when a pen, a finger or the like is moved within the aforementioned rectangular frame, some light beams from the aforementioned light-emitting elements are intercepted by the tip of the pen, the finger or the like. The light-receiving elements opposed to the aforementioned light-emitting elements sense the interception of light beams to thereby detect the path of the aforementioned pen tip, fingertip or the like (input information such as a character). The path is outputted as a signal to the aforementioned display.

The aforementioned optical position detection device is in the form of a rectangular frame. Thus, a paper sheet may be placed under the optical position detection device so that part of the paper sheet is revealed within the frame. In this state, while a user directly writes a character and the like on the revealed part of the paper sheet with a writing implement such as a pen, the character and the like may be caused to appear on the aforementioned display.

However, if the optical position detection device and the paper sheet are displaced in position relative to each other during the writing, the position of the character and the like written on the paper sheet (analog data) and the position of the character and the like appearing on the display (digital data) do not coincide with each other (or a difference occurs between the analog data and the digital data). Also, if the user suspends writing on a paper sheet to take out the paper sheet from the optical position detection device and thereafter sets the paper sheet under the optical position detection device to write again, there arises positional displacement from the preceding position of the paper sheet. When the user writes a character or the like on the paper sheet in that state, the character or the like can be written so as not to be displaced from the preceding position on the paper sheet, but appears on the display as being displaced in position (or a difference occurs between the analog data and the digital data).

### SUMMARY OF THE INVENTION

An underlay-board-equipped input device is provided which is capable of preventing positional displacement of a writing paper sheet when a user is writing on the set writing paper sheet and when the writing paper sheet is set again.

The underlay-board-equipped input device according to a first aspect comprises: an input device including a frame-shaped plate having the shape of a frame surrounding a space serving as a hollow input-use interior, a light-emitting means provided on one of a pair of opposed sections of the frame-shaped plate, and a light-receiving means provided on the other of the opposed sections of the frame-shaped plate and for receiving light beams emitted from the light-emitting means; and an underlay board mounted to the back surface of the input device pivotably about one end edge of the input device, the underlay board including a means for positioning a writing paper sheet on the front surface of the underlay board, the front surface of the underlay board and the back surface of the input device being configured to form a holding part for holding the writing paper sheet therebetween.

Further, an underlay-board-equipped input device according to a second aspect comprises: an input device including a frame-shaped plate having the shape of a frame surrounding a space serving as a hollow input-use interior, a light-emitting means provided on one of a pair of opposed sections of the frame-shaped plate, and a light-receiving means provided on the other of the opposed sections of the frame-shaped plate and for receiving light beams emitted from the light-emitting means; and an underlay board removably engaging the back surface of the input device, the underlay board including a mounting table formed on the front surface of the underlay board and for placing a writing paper sheet thereon, part of the back surface of the input device corresponding to a peripheral portion of the mounting table being formed in a shape corresponding to the peripheral portion of the mounting table, the peripheral portion of the mounting table and the part of the back surface of the input device being removably engageable with each other, the mounting table having an outer peripheral side surface corresponding to the outer periphery of the writing paper sheet, the peripheral portion of the mounting table and the back surface of the input device being configured to form a holding part for holding the writing paper sheet therebetween.

Also, an underlay-board-equipped input device according to a third aspect comprises: an input device including a frame-shaped plate having the shape of a frame surrounding a space serving as a hollow input-use interior, a light-emitting means provided on one of a pair of opposed sections of the frame-shaped plate, and a light-receiving means provided on the other of the opposed sections of the frame-shaped plate and for receiving light beams emitted from the light-emitting means; and an underlay board fixed to the back surface of the input device, one side of inner peripheral edges of the hollow input-use interior being formed as a positioning reference side for positioning one side of outer peripheral edges of a writing paper sheet, there being provided fixed pieces at corners lying on opposite ends of the positioning reference side, the back surface of the fixed pieces and the front surface of the underlay board being configured to form a part for holding two adjacent corners of the writing paper sheet therebetween.

Specifically, the process of writing on the writing paper sheet by using the underlay-board-equipped input device according to the first aspect is as follows. First, the input device and the underlay board are pivoted relative to each other about the one end edge of the input device into an open condition. Then, the writing paper sheet is properly positioned and set on the front surface of the aforementioned underlay board by using the means for positioning the writing paper sheet. Next, the input device and the underlay board are pivoted relative to each other into a closed condition. By such closing, the writing paper sheet is held and fixed between the front surface of the underlay board and the back surface of the input device. In this state, a user writes on the writing paper sheet. For the removal of the writing paper sheet, the input device and the underlay board are pivoted again relative to each other into an open condition, and the writing paper sheet is then removed.

Also, the process of writing on the writing paper sheet by using the underlay-board-equipped input device according to the second aspect is as follows. When the input device and the underlay board are not in engagement with each other, the writing paper sheet is placed on the aforementioned mounting table so that the outer periphery of the writing paper sheet is along the outer peripheral side surface of the mounting table formed on the underlay board, whereby the aforementioned writing paper sheet is properly positioned. Then, the peripheral portion of the mounting table and the part of the back surface of the input device are brought into engagement with each other. By this engagement, the peripheral portion of the writing paper sheet is held and fixed between the peripheral portion of the mounting table and the back surface of the aforementioned input device. In this state, the user writes on the writing paper sheet. For the removal of the writing paper sheet, the input device and the underlay board are brought out of engagement with each other again, and the writing paper sheet is then removed.

Further, the process of writing on the writing paper sheet by using the underlay-board-equipped input device according to the third aspect is as follows. The two adjacent corners of the writing paper sheet are slid in between the fixed pieces provided at the two corners of the hollow input-use interior and the underlay board, and the one side lying between the aforementioned two corners of the writing paper sheet is brought into abutment against the one side (the positioning reference side) lying between the aforementioned two fixed pieces in the hollow input-use interior. By this abutment, the aforementioned two corners of the writing paper sheet are held between the back surface of the fixed pieces and the front surface of the aforementioned underlay board, whereby the writing paper sheet is fixed. The one side of the writing paper sheet abuts against the positioning reference side in the hollow input-use interior, whereby the writing paper sheet is positioned properly. In this state, the user writes on the writing paper sheet. For the removal of the writing paper sheet, the aforementioned two corners of the writing paper sheet are pulled out from between the back surface of the fixed pieces and the front surface of the aforementioned underlay board, so that the writing paper sheet is removed.

In the underlay-board-equipped input device according to the first aspect, the underlay board is mounted to the back surface of the input device pivotably about the one end edge of the input device. Thus, when the aforementioned input device and the aforementioned underlay board are pivoted relative to each other into an open condition, the positional displacement thereof relative to each other does not occur. The means for positioning the writing paper sheet is provided on the front surface of the aforementioned underlay board. For setting the writing paper sheet again, the positioning means is used to place the writing paper sheet in proper position. Additionally, since the positional displacement of the input device and the underlay board relative to each other does not occur as mentioned above, the positional displacement of the aforementioned writing paper sheet and the input device relative to each other does not occur. Further, the front surface of the aforementioned underlay board and the back surface of the aforementioned input device are configured to form the holding part for holding the aforementioned writing paper sheet therebetween. Thus, the positional displacement of the writing paper sheet does not occur during writing on the writing paper sheet. Also, the underlay board is mounted to the aforementioned input device as mentioned above. Thus, the aforementioned input device, although frame-shaped, is increased in rigidity. This achieves the detection of the movement path of the tip portion (such as a pen tip) of a writing implement with higher accuracy.

In particular, when the aforementioned means for positioning the writing paper sheet includes a plurality of protrusions for insertion through a plurality of through holes previously formed in the writing paper sheet, the aforementioned protrusions are inserted through the through holes previously formed in the aforementioned writing paper sheet, whereby the aforementioned writing paper sheet is properly positioned and is prevented from being displaced in position.

Also, when the aforementioned means for positioning the writing paper sheet includes mark lines indicating the outer periphery of the writing paper sheet, the aforementioned writing paper sheet is placed so that the outer periphery of the aforementioned writing paper sheet is along the aforementioned mark lines, whereby the aforementioned writing paper sheet is properly positioned.

Further, when the aforementioned means for positioning the writing paper sheet includes an anti-slip member disposed in corresponding relation to the outer periphery of the writing paper sheet, the aforementioned writing paper sheet is placed so that the outer periphery of the aforementioned writing paper sheet corresponds to the disposition of the aforementioned anti-slip member, whereby the aforementioned writing paper sheet is properly positioned, and it is more difficult for the aforementioned writing paper sheet to be displaced in position.

When the aforementioned means for positioning the writing paper sheet includes a mounting table for placing the writing paper sheet thereon and having an outer peripheral side surface corresponding to the outer periphery of the writing paper sheet, the aforementioned writing paper sheet is placed on the aforementioned mounting table so that the outer periphery of the aforementioned writing paper sheet is along the outer peripheral side surface of the aforementioned mounting table, whereby the aforementioned writing paper sheet is properly positioned. Additionally, a user is able to recognize the outer peripheral side surface of the aforementioned mounting table by touching with a hand or a finger. This facilitates the positioning of the writing paper sheet.

In particular, when an accommodating portion for accommodating a battery for driving the input device is formed inside a thick part of the underlay board where the mounting table is formed, the inside of the aforementioned mounting table is effectively used. This reduces the thickness of the entire underlay-board-equipped input device according to the first aspect.

In the underlay-board-equipped input device according to the second aspect, the mounting table for placing the writing paper sheet thereon is formed on the front surface of the underlay board, and the part of the back surface of the aforementioned input device corresponding to the peripheral portion of the mounting table is formed in a shape corresponding to the peripheral portion of the mounting table. The removable engagement between the peripheral portion of the mounting table and the part of the back surface of the input device allows the removable engagement between the input device and the underlay board without the positional displacement thereof relative to each other. Also, the outer peripheral side surface of the aforementioned mounting table corresponds to the outer periphery of the aforementioned writing paper sheet. Thus, the aforementioned writing paper sheet is placed on the aforementioned mounting table so that the outer periphery of the aforementioned writing paper sheet is along the outer peripheral side surface of the aforementioned mounting table, whereby the aforementioned writing paper sheet is properly positioned. Further, the peripheral portion of the aforementioned mounting table and the back surface of the aforementioned input device are configured to form the holding part for holding the aforementioned writing paper sheet therebetween. Thus, the positional displacement of the writing paper sheet does not occur during writing on the writing paper sheet.

In the underlay-board-equipped input device according to the third aspect, the underlay board is fixed to the back surface of the input device, so that the positional displacement of the aforementioned input device and the aforementioned underlay board relative to each other does not occur. The one side of the inner peripheral edges of the hollow input-use interior of the aforementioned input device is formed as the positioning reference side for positioning one side of the outer peripheral edges of the writing paper sheet, and the fixed pieces are provided at the corners lying on opposite ends of the positioning reference side. The back surface of the fixed pieces and the front surface of the aforementioned underlay board are configured to form the part for holding two adjacent corners of the aforementioned writing paper sheet therebetween. Thus, the positioning and fixing of the aforementioned writing paper sheet are achieved by holding two adjacent corners of the writing paper sheet between the back surface of the aforementioned fixed pieces and the front surface of the aforementioned underlay board, and by bringing one side lying between the aforementioned two corners of the writing paper sheet into abutment against the positioning reference side of the inner peripheral edges of the aforementioned hollow input-use interior. That is, the positional displacement of the writing paper sheet does not occur when a user is writing on the writing paper sheet and when the writing paper sheet is set again. Further, the underlay board is fixed to the aforementioned input device as mentioned above. Thus, the aforementioned input device, although frame-shaped, is increased in rigidity. This achieves the detection of the movement path of the tip portion (such as a pen tip) of a writing implement with higher accuracy.

In particular, in the underlay-board-equipped input device according to the first to third aspects, the light-emitting means includes a light-emitting element, and a plurality of light-emitting cores of an optical waveguide, the light-emitting cores being connected to the light-emitting element; the light-receiving means includes a light-receiving element, and a plurality of light-receiving cores of the optical waveguide, the light-receiving cores being connected to the light-receiving element; and tips of the light-emitting cores and tips of the light-receiving cores are opposed to each other while being positioned on inner edges of the frame-shaped plate. In such a case, the aforementioned optical waveguide is formed on the aforementioned frame-shaped plate, and the optical waveguide is made thin. Thus, when the user performs an input operation with a writing implement such as pen, the aforementioned input device does not serve as an impediment to the input operation. This facilitates the input operation.

On the other hand, in the underlay-board-equipped input device according to the first to third aspects, the light-emitting means includes a plurality of light-emitting elements; the light-receiving means includes a plurality of light-receiving elements; and the light-emitting elements and the light-receiving elements are opposed to each other while being positioned on inner edges of the frame-shaped plate. In such a case, the aforementioned light-emitting elements and the aforementioned light-receiving elements have a certain amount of thickness, and the aforementioned input device accordingly has a certain amount of thickness as a whole. This allows the input device to have a certain amount of rigidity and strength.

Also, in the underlay-board-equipped input device according to the first to third aspects, the light-emitting means and the light-receiving means include two modules disposed on respective corners lying on opposite ends of one side of the frame-shaped plate, each of the two modules including a light-emitting element and a light-receiving element which are stacked vertically; a retroreflector in the form of a tape is affixed to inner side surface of three sides other than the one side lying between the modules; and light beams projected from the light-emitting element of one of the modules are reflected from the retroreflector and are then received by the light-receiving element of the one module. In such a case, the movement path of the tip portion (such as a pen tip) of a writing implement is detected based on triangulation through the use of a smaller number of components.

### BRIEF DESCRIPTION OF THE DRAWINGS

FIG. 1 is a perspective view schematically showing a first preferred embodiment of an underlay-board-equipped input device according to a first aspect.

FIG. 2 is a sectional view schematically showing the underlay-board-equipped input device which is closed to hold a writing paper sheet between components thereof.

FIG. 3A is a plan view schematically showing part of the underlay-board-equipped input device corresponding to an input device.

FIG. 3B is a sectional view, on an enlarged scale, taken along the line X1-X1 of FIG. 3A.

FIG. 3C is a sectional view, on an enlarged scale, taken along the line X2-X2 of FIG. 3A.

FIGS. 4A to 4C are views schematically illustrating an exemplary method of producing the input device.

FIGS. 5A to 5C are views schematically illustrating the method of producing the input device subsequent to the steps shown in FIGS. 4A to 4C.

FIGS. 6A and 6B are views schematically illustrating the method of producing the input device subsequent to the steps shown in FIGS. 5A to 5C.

FIG. 7A is a view schematically illustrating the method of producing the input device subsequent to the steps shown in FIGS. 6A and 6B.

FIG. 7B is a sectional view taken along the line X4-X4 of FIG. 7A.

FIG. 8 is a view schematically illustrating the method of producing the input device subsequent to the steps shown in FIGS. 7A and 7B.

FIG. 9 is a perspective view schematically showing a second preferred embodiment of the underlay-board-equipped input device according to the first aspect.

FIG. 10 is a perspective view schematically showing a third preferred embodiment of the underlay-board-equipped input device according to the first aspect.

FIG. 11A is a perspective view schematically showing a fourth preferred embodiment of the underlay-board-equipped input device according to the first aspect.

FIG. 11B is a sectional view of the underlay-board-equipped input device of FIG. 11A in a closed condition.

FIG. 12 is a sectional view schematically showing a fifth preferred embodiment of the underlay-board-equipped input device in a closed condition according to the first aspect.

FIG. 13 is a sectional view schematically showing a sixth preferred embodiment of the underlay-board-equipped input device in a closed condition according to the first aspect.

FIG. 14 is a sectional view schematically showing a seventh preferred embodiment of the underlay-board-equipped input device in a closed condition according to the first aspect.

FIG. 15 is a sectional view schematically showing an eighth preferred embodiment of the underlay-board-equipped input device in a closed condition according to the first aspect.

FIG. 16A is a perspective view schematically showing a ninth preferred embodiment of the underlay-board-equipped input device according to a second aspect.

FIG. 16B is a sectional view of the underlay-board-equipped input device of FIG. 16A in an engaged condition.

FIG. 17 is a perspective view schematically showing a tenth preferred embodiment of the underlay-board-equipped input device according to a third aspect.

FIG. 18 is a plan view schematically showing another form of the part of the underlay-board-equipped input device corresponding to the input device.

FIG. 19 is a plan view schematically showing still another form of the part of the underlay-board-equipped input device corresponding to the input device.

### DETAILED DESCRIPTION OF THE INVENTION

Next, preferred embodiments according to the present invention will now be described in detail with reference to the drawings.

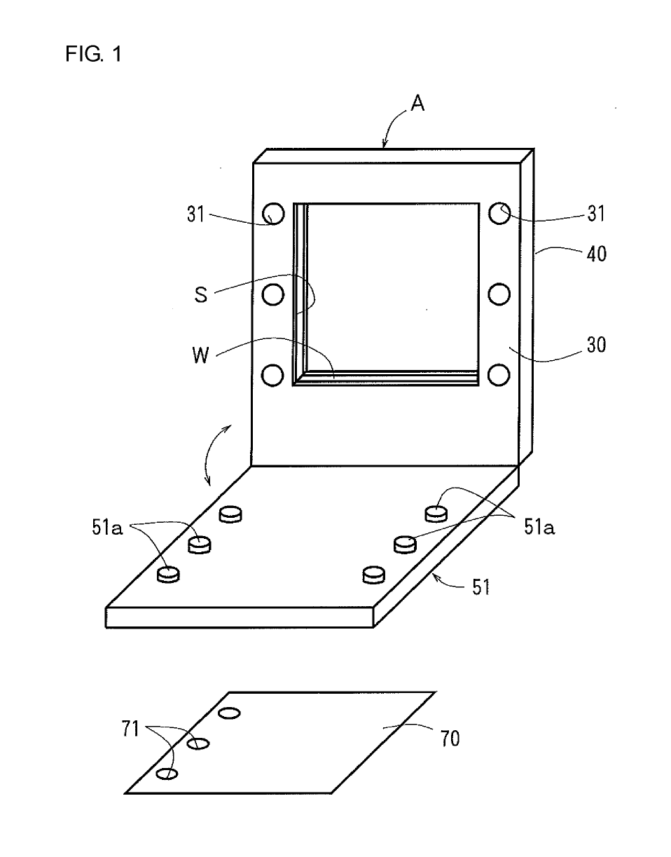

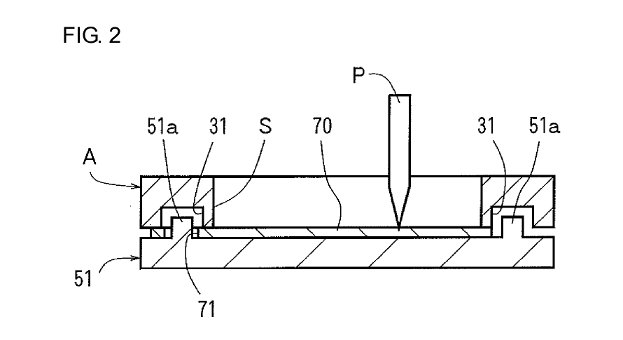

FIG. 1 is a perspective view showing a first preferred embodiment of an underlay-board-equipped input device according to a first aspect. FIG. 2 is a sectional view showing the underlay-board-equipped input device which is closed to hold a writing paper sheet 70 between components thereof. The underlay-board-equipped input device according to this preferred embodiment includes: a rectangular frame-shaped input device A having a rectangular hollow input-use interior (window) S; and an underlay board 51 integrally mounted to the back surface of the input device A pivotably about one end edge of this input device A. This underlay board 51 is larger than the area of the hollow input-use interior S so as to be able to cover the entire hollow input-use interior S, and is of the same configuration as the outer periphery of the input device A in this preferred embodiment. A means for positioning the writing paper sheet 70 placed on the front surface of the underlay board 51 is provided on the front surface of the underlay board 51. The positioning means in this preferred embodiment includes an array of protrusions 51a formed in a pair of opposed end edge portions of the front surface of the underlay board 51 and configured for insertion through a plurality of through holes 71 previously formed in the writing paper sheet 70. Also in this preferred embodiment, insertion holes 31 for receiving the aforementioned protrusions 51a are formed in the back surface of the input device A. A peripheral portion of the writing paper sheet 70 is adapted to be held between the back surface of a peripheral portion of the hollow input-use interior S of the input device A and the front surface of the underlay board 51. The aforementioned underlay board 51 is mounted to the back surface of the aforementioned input device A in this manner.

For setting the writing paper sheet 70 on the underlay-board-equipped input device in this preferred embodiment, a commercially available writing paper sheet such that the aforementioned through holes 71 are formed in one end edge portion thereof is prepared as the writing paper sheet 70. Then, the input device A and the underlay board 51 are pivoted relative to each other about one end edge of the input device A into an open condition. Next, the protrusions 51a of the underlay board 51 are inserted through the through holes 71 of the aforementioned writing paper sheet 70, so that the writing paper sheet 70 is placed on the front surface of the underlay board 51. This placement allows the proper positioning of the writing paper sheet 70, and prevents the positional displacement of the writing paper sheet 70. Next, the input device A and the underlay board 51 are pivoted relative to each other into a closed condition. By such closing, a portion of the writing paper sheet 70 around the through holes 71 is held between a portion of the front surface of the underlay board 51 around the protrusions 51a and a portion of the back surface of the input device A around the insertion holes 31, and a peripheral portion of the writing paper sheet 70 except where the aforementioned through holes 71 are formed is held between the front surface of the underlay board 51 and the back surface of the peripheral portion of the hollow input-use interior S of the input device A, so that the writing paper sheet 70 is fixed. Thus, when a user writes with a pen P on part of the writing paper sheet 70 revealed within the hollow input-use interior S of the input device A in this state, the writing paper sheet 70 is not displaced in position. For the removal of the writing paper sheet 70, the input device A and the underlay board 51 are pivoted again relative to each other into an open condition, and the writing paper sheet 70 is then removed. For setting the writing paper sheet 70 again, the writing paper sheet 70 is set in a manner similar to that described above. Thus, the writing paper sheet 70 is placed in the same position as last time, and is not displaced in position.

Further, the aforementioned underlay board 51 is mounted pivotably about the one end edge of the input device A. Thus, when the input device A and the underlay board 51 are pivoted relative to each other into an open condition, the positional displacement thereof relative to each other does not occur. Therefore, the positional displacement of the writing paper sheet 70 positioned and set on the front surface of the underlay board 51 in the aforementioned manner and the input device A relative to each other does not occur.

Also in this preferred embodiment, the aforementioned protrusions 51a are formed in the opposed end edge portions. Thus, some of the protrusions 51a formed in one of the end edge portions are used for the positioning when the user writes on the front surface of the writing paper sheet 70, and some of the protrusions 51a formed in the other end edge portion are used for the positioning when the user writes on the back surface of the writing paper sheet 70. This allows the writing on the opposite surfaces of the writing paper sheet 70.

An example of a structure for rendering the aforementioned underlay board 51 pivotable is such that an insertion hole (not shown) for receiving a shaft (not shown) is formed on each of the one end edge of the input device A and one end edge of the underlay board 51 and such that the shaft is inserted through the insertion holes. With such a structure, the input device A and the underlay board 51 are rendered pivotable relative to each other about the one end edges thereof. Any end edge of the input device A may serve as the axis of the aforementioned pivot.

The protrusions 51a of the underlay board 51 have such a height as to allow the insertion of a single writing paper sheet 70, and are in the range of 0.5 to 5.0 mm in height, for example. The depth of the insertion holes 31 of the aforementioned input device A for the insertion of the protrusions 51a is set to a depth which allows the insertion of the whole of the aforementioned protrusions 51a.

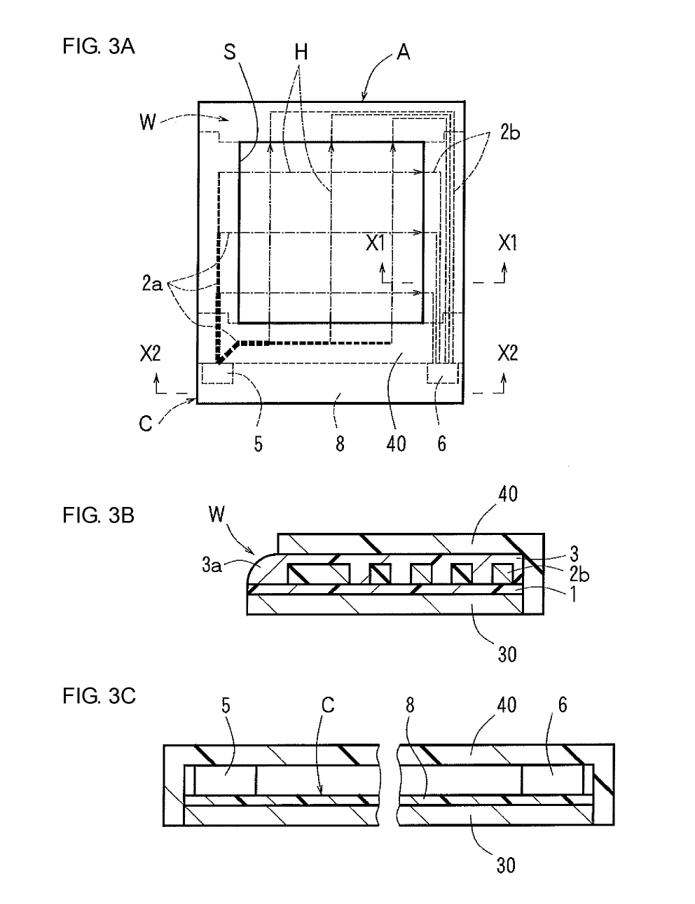

The aforementioned input device A will be described in detail. As shown in FIG. 3A in plan view, shown in FIG. 3B in sectional view on an enlarged scale taken along the line X1-X1 of FIG. 3A and shown in FIG. 3C in sectional view on an enlarged scale taken along the line X2-X2 of FIG. 3A, the input device A includes a rectangular frame-shaped optical waveguide W having the rectangular hollow input-use interior S, and a control means C provided on the outside of one of the sides of the optical waveguide W. The optical waveguide W and the control means C are provided on the front surface of a rectangular frame-shaped retainer plate (frame-shaped plate) 30 having the aforementioned hollow input-use interior S, and are covered with a rectangular frame-shaped protective plate 40 having the aforementioned hollow input-use interior S. The control means C includes a light-emitting element 5 connected to ends of light-emitting cores 2a of the aforementioned optical waveguide W, and a light-receiving element 6 connected to ends of light-receiving cores 2b of the aforementioned optical waveguide W.

As shown in FIGS. 3A and 3B, the aforementioned rectangular frame-shaped optical waveguide W is configured such that strip-shaped optical waveguide sections corresponding to the respective sides of the rectangular frame shape of the optical waveguide W are produced individually and then connected together into the shape of the rectangular frame. In this preferred embodiment, opposite end edges of each of the strip-shaped optical waveguide sections have step portions. Adjacent ones of the optical waveguide sections, which are positioned using the step portions, are connected to each other. Each of the strip-shaped optical waveguide sections includes an under cladding layer 1, the cores 2a and 2b formed in a predetermined pattern on a surface of the under cladding layer 1, and an over cladding layer 3 formed on the surface of the aforementioned under cladding layer 1 so as to cover the cores 2a and 2b. The aforementioned under cladding layer 1 is affixed to the front surface of the aforementioned rectangular frame-shaped retainer plate 30.

In the aforementioned optical waveguide W in the form of a rectangular frame, the under cladding layer 1 is in the form of a rectangular frame comprised of a pair of L-shaped sections. The light-emitting cores 2a are disposed in a divided manner on the surface of one of the L-shaped sections, and the light-receiving cores 2b are disposed in juxtaposition on the surface of the other L-shaped section. The cores 2a and 2b have respective tips positioned on the inner edges of the aforementioned pair of L-shaped sections (the inner peripheral edges of the rectangular frame). The tips of the light-emitting cores 2a are in opposed relation to the tips of the light-receiving cores 2b. The over cladding layer 3 in the form of a rectangular frame is formed on the surface of the aforementioned under cladding layer 1 so as to cover the aforementioned light-emitting cores 2a and the light-receiving cores 2b. In this preferred embodiment, each of the tips of the cores 2a and 2b positioned on the inner peripheral edges of the aforementioned rectangular frame is in the form of a convex lens portion having a substantially semicircular curved surface as seen in plan view, and an edge portion of the over cladding layer 3 covering the lens portions is in the form of a convex lens portion 3a having a substantially quadrantal curved surface as seen in sectional side view. In FIG. 3A, the cores 2a and 2b are indicated by broken lines, and the thickness of the broken lines indicates the width of the cores 2a and 2b. Also, in FIGS. 3A and 3B, the number of cores 2a and 2b are shown as abbreviated.

As shown in FIGS. 3A and 3C, the aforementioned control means C further includes a CPU (central processing unit) (not shown) for controlling the aforementioned input device A, an output module (not shown) for outputting information inputted in a region within the hollow input-use interior S of the aforementioned optical waveguide W (information about the movement path of a pen tip and the like), a storage means (not shown) for storing the information therein, a battery (not shown) serving as a power source, and the like, in addition to the light-emitting element 5 and the light-receiving element 6 described earlier. The aforementioned light-emitting element 5, the aforementioned light-receiving element 6, the aforementioned CPU, the aforementioned output module, the aforementioned storage means, the aforementioned battery and the like are mounted on a circuit board 8, and are electrically properly connected.

In such an input device A, light beams H from the aforementioned light-emitting element 5 pass through the aforementioned light-emitting cores 2a and through the lens portions at the tips of the respective light-emitting cores 2a, and then exit the surface of the lens portion 3a of the over cladding layer 3 covering the lens portions of the respective light-emitting cores 2a. Upon exiting, the light beams H travel in a lattice form in the region within the hollow input-use interior S of the aforementioned rectangular frame-shaped optical waveguide W. The light beams H traveling in a lattice form are restrained from diverging by refraction through the lens portions at the tips of the aforementioned light-emitting cores 2a and through the lens portion 3a of the over cladding layer 3 covering the lens portions of the cores 2a. The aforementioned light beams H are transmitted through the lens portion 3a on a light-receiving side of the over cladding layer 3 and through the lens portions at the tips of the respective light-receiving cores 2b. Then, the light beams H pass through the aforementioned light-receiving cores 2b to reach the aforementioned light-receiving element 6. The light beams entering the aforementioned light-receiving cores 2b are narrowed down and converged by refraction through the lens portion 3a of the aforementioned over cladding layer 3 and through the lens portions at the tips of the aforementioned light-receiving cores 2b.

Then, the writing paper sheet 70 (with reference to FIG. 2) is positioned and fixed in the aforementioned manner in the aforementioned underlay-board-equipped input device. The writing of information on the writing paper sheet 70 is as follows. The user writes a character, a drawing, a mark or the like with the pen P on part of the aforementioned writing paper sheet 70 revealed within the aforementioned hollow input-use interior S where the light beams H travel in the lattice form as mentioned above. Because of the writing, some of the light beams H traveling in the aforementioned lattice form are intercepted by the pen tip of the aforementioned pen P. The aforementioned light-receiving element 6 senses the interception of light beams to thereby detect the path of the aforementioned pen tip. The path of the pen tip serves as input information such as a character, a drawing, a mark or the like. It is preferable that the height of the light beams H traveling in the lattice form is in the range of 0.2 to 1.0 mm as measured from the front surface of the writing paper sheet 70 from the viewpoint of detecting the pen tip.

The aforementioned underlay-board-equipped input device is used together with, for example, a personal computer (referred to hereinafter as a “PC”). Specifically, when information such as a document is displayed on a display for the aforementioned PC and a user adds information such as a character, a drawing and a mark to the displayed information, the user inputs the information such as a character into the region within the hollow input-use interior S of the aforementioned input device A with the pen P as described above. In response to the input with the pen, the aforementioned input device A detects the path of the pen tip, and transmits the path as a signal to the aforementioned PC by radio or through a connecting cable, so that the information appears on the aforementioned display. The information such as a character inputted by means of the aforementioned input device A which is superimposed on the aforementioned information such as a document appears on the aforementioned display.

Software (a program) for converting coordinates in the region within the hollow input-use interior S of the input device A into coordinates on the screen of the display to display a character or the like inputted by means of the input device A on the display is incorporated in the aforementioned PC used herein for the purpose of displaying the character or the like inputted in the hollow input-use interior S of the aforementioned input device A in a position on the display corresponding to the input position.

It should be noted that the aforementioned information such as a document is, in general, previously stored in an information storage medium such as a hard disk in the aforementioned PC and an external USB memory device, and is outputted from the information storage medium. The information appearing on the aforementioned display which is the superimposition of the information such as a character inputted by means of the aforementioned input device A on the aforementioned information such as a document may be stored in the aforementioned information storage medium.

In the first preferred embodiment, the protrusions 51a for use in the positioning of the writing paper sheet 70 are formed in the opposite end edge portions perpendicular to the pivotal axis, as shown in FIG. 1. However, the protrusions 51a may be formed in opposite end edge portions parallel to the pivotal axis. Also, the aforementioned protrusions 51a may be formed only in one end edge portion of the front surface of the underlay board 51.

### <Production of Underlay Board 51>

Next, an exemplary method of producing the aforementioned underlay board 51 will be described. Examples of a material for the formation of this underlay board 51 include metal, resin, wood, and glass. The aforementioned underlay board 51 is produced by a manufacturing method depending on the material for the formation thereof. For example, the underlay board 51 is produced by press working of a metal plate and the like when metal is used as the material for the formation thereof, and is produced by injection molding and the like when resin is used.

### <Production of Input Device A>

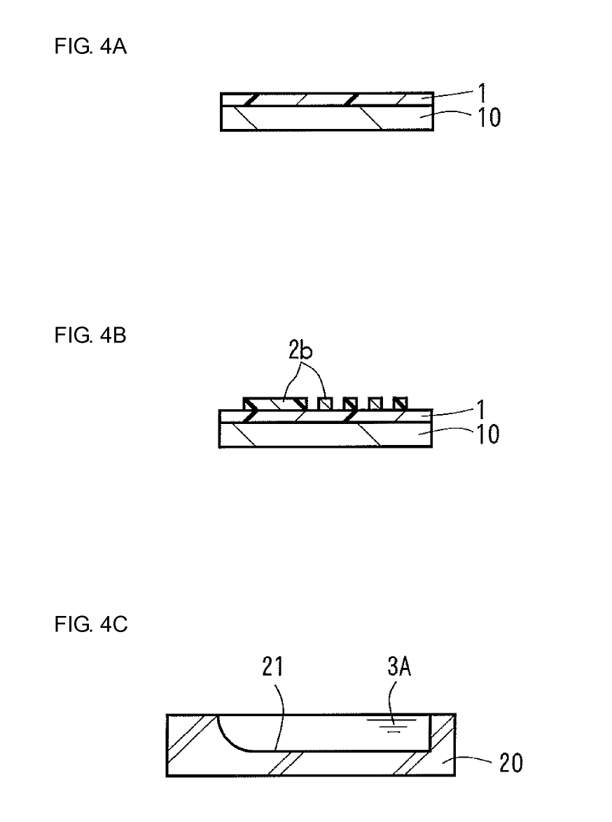

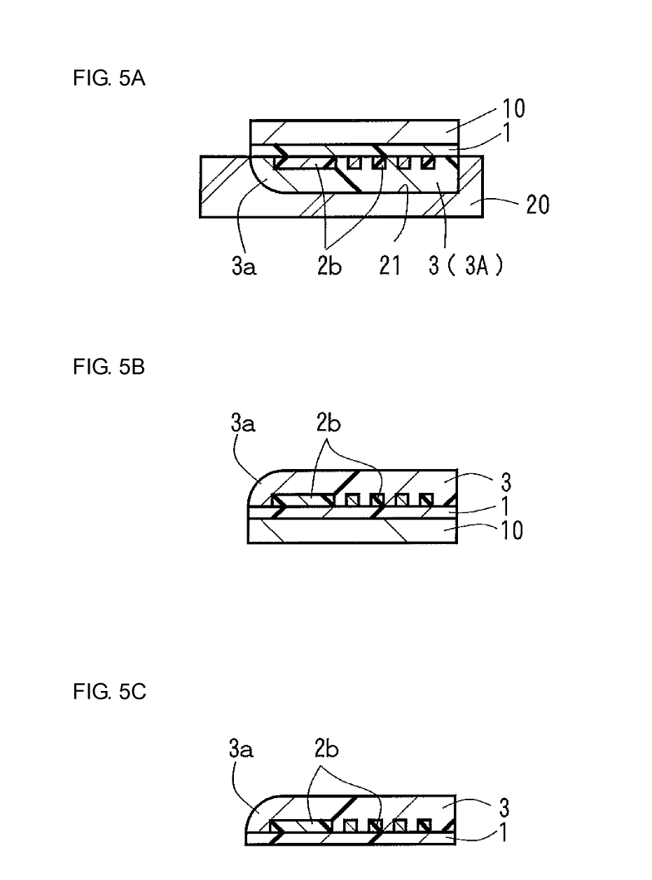

Next, an exemplary method of producing the aforementioned input device A will be described. In this preferred embodiment, the rectangular frame-shaped optical waveguide W is produced by individually producing the strip-shaped optical waveguide sections corresponding to the respective sides of the rectangular frame shape of the optical waveguide W and then connecting the strip-shaped optical waveguide sections together into the shape of the rectangular frame. It should be noted that FIGS. 4A to 4C, and 5A to 5C referenced for description on the method of producing the optical waveguide W show portions corresponding to the cross section taken along the line X1-X1 of FIG. 3A.

First, a substrate 10 for the formation of each of the strip-shaped optical waveguide sections (with reference to FIG. 4A) is prepared. Examples of a material for the formation of this substrate 10 include metal, resin, glass, quartz, and silicon.

Then, as shown in FIG. 4A, the strip-shaped under cladding layer 1 is formed on a surface of the aforementioned substrate 10. This under cladding layer 1 may be formed by a photolithographic method using a photosensitive resin as a material for the formation thereof. The under cladding layer 1 has a thickness in the range of 5 to 50 μm, for example.

Next, as shown in FIG. 4B, the light-emitting cores 2a and the light-receiving cores 2b which have the aforementioned pattern are formed on the surface of the aforementioned under cladding layer 1 by a photolithographic method. An example of a material for the formation of the cores 2a and 2b used herein includes a photosensitive resin having a refractive index higher than that of the materials for the formation of the aforementioned under cladding layer 1 and the over cladding layer 3 to be described below (with reference to FIG. 5B).

As shown in FIG. 4C, a light-transmissive mold 20 for the formation of the over cladding layer is prepared. The mold 20 includes a cavity 21 having a mold surface complementary in shape to the surface of the over cladding layer 3 (with reference to FIG. 5B). The mold 20 is placed on a molding stage (not shown), with the cavity 21 positioned to face upward. Then, the cavity 21 is filled with a photosensitive resin 3A serving as the material for the formation of the over cladding layer 3.

Then, as shown in FIG. 5A, the cores 2a and 2b patterned on the surface of the aforementioned under cladding layer 1 are positioned relative to the cavity 21 of the aforementioned mold 20. In that state, the aforementioned under cladding layer 1 is pressed against the aforementioned mold 20, so that the aforementioned cores 2a and 2b are immersed in the photosensitive resin 3A serving as the material for the formation of the aforementioned over cladding layer 3. In this state, the aforementioned photosensitive resin 3A is exposed to irradiation light such as ultraviolet light by directing the irradiation light through the aforementioned mold 20 onto the aforementioned photosensitive resin 3A. This exposure cures the aforementioned photosensitive resin 3A to form the over cladding layer 3 in which part of the over cladding layer 3 corresponding to the tips of the cores 2a and 2b is formed as the lens portion 3a.

Next, as shown in FIG. 5B (shown in an orientation vertically inverted from that shown in FIG. 5A), the aforementioned over cladding layer 3 together with the aforementioned substrate 10, the under cladding layer 1, and the cores 2a and 2b is removed from the aforementioned mold 20 (with reference to FIG. 5A).

Then, as shown in FIG. 5C, the aforementioned substrate 10 (with reference to FIG. 4B) is stripped from the under cladding layer 1. This provides each of the strip-shaped optical waveguide sections including the under cladding layer 1, the cores 2a and 2b, and the over cladding layer 3.

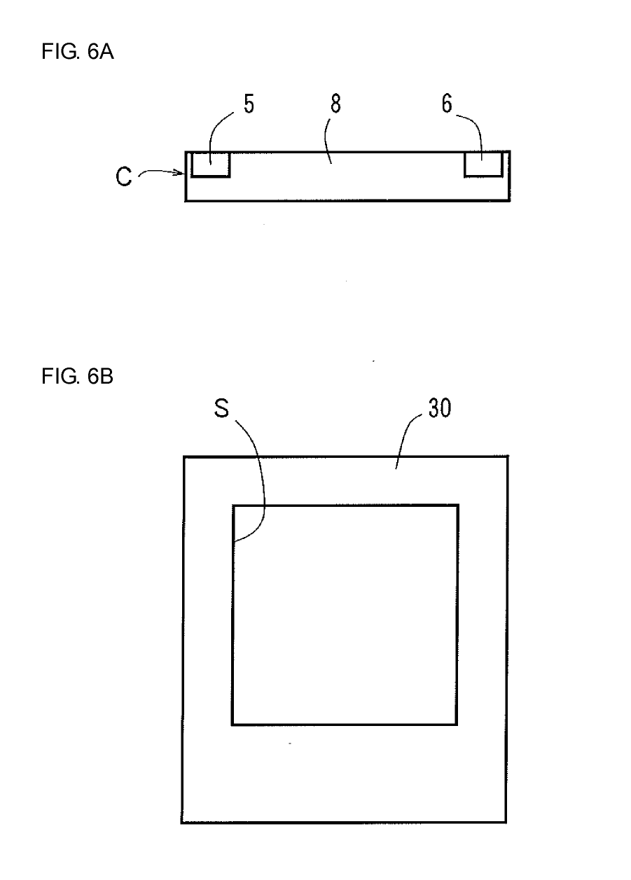

Next, as shown in plan view in FIG. 6A, the circuit board 8 is prepared, and the aforementioned control means C is produced by mounting on the circuit board 8 the following parts: the light-emitting element 5, the light-receiving element 6, the CPU (not shown) for controlling the aforementioned input device A (with reference to FIG. 1), the output module (not shown) for outputting information inputted into the region within the hollow input-use interior S of the aforementioned optical waveguide W (with reference to FIG. 1), the aforementioned storage means (not shown), the battery (not shown), and the like.

The rectangular frame-shaped retainer plate 30 having the hollow input-use interior S is prepared, as shown in plan view in FIG. 6B. Examples of a material for the formation of the retainer plate 30 include metal, resin, glass, quartz, and silicon. In particular, stainless steel is preferable in having a good ability to hold the planarity thereof. The aforementioned insertion holes 31 (with reference to FIG. 1) are formed in the back surface of the retainer plate 30 by cutting, etching and the like.

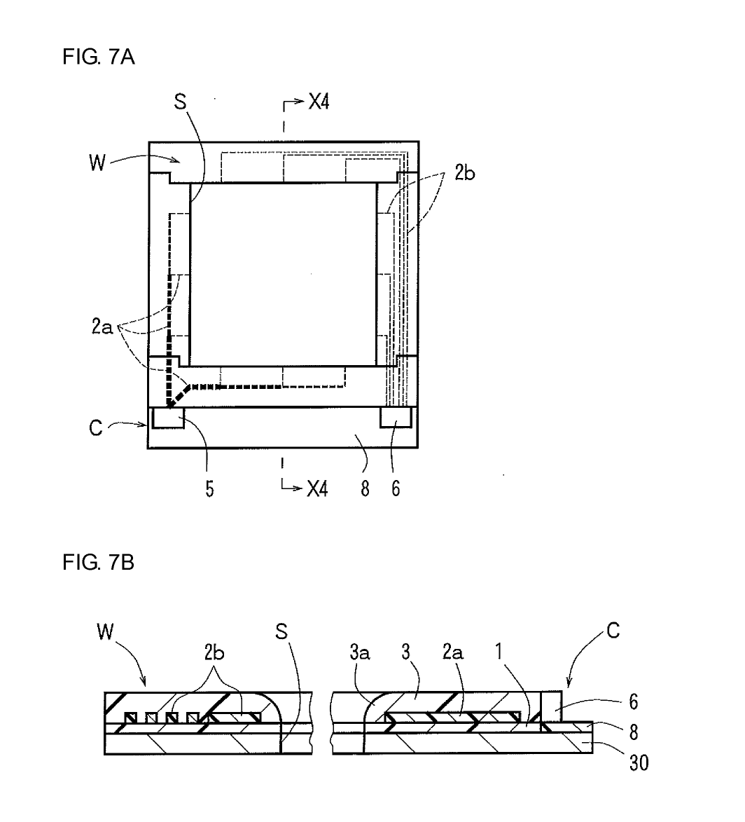

As shown in FIG. 7A in plan view and shown in FIG. 7B in sectional view (a sectional view taken along the line X4-X4 of FIG. 7A), the aforementioned strip-shaped optical waveguide sections are affixed to the front surface of the aforementioned rectangular frame-shaped retainer plate 30 to produce the rectangular frame-shaped optical waveguide W. At this time, the aforementioned light-emitting element 5 is connected to the light-emitting cores 2a, and the aforementioned light-receiving element 6 is connected to the light-receiving cores 2b.

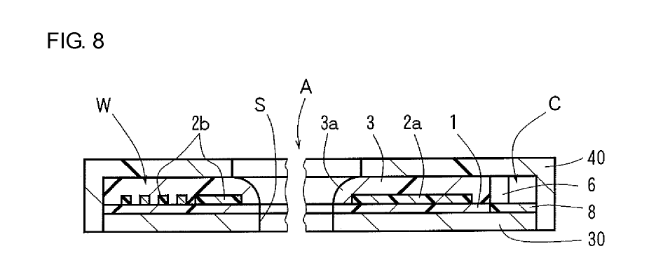

Thereafter, as shown in sectional view in FIG. 8, the top surface and outer peripheral surface of the aforementioned over cladding layer 3 except the lens portion 3a, and the whole of the aforementioned control means C are covered with the protective plate 40. Examples of a material for the formation of the protective plate 40 include resin, metal, glass, quartz, and silicon. The protective plate 40 has a thickness of approximately 0.5 mm when made of metal, and approximately 0.8 mm when made of resin, for example. In this manner, the aforementioned input device A is produced.

### <Production of Underlay-Board-Equipped Input Device>

Finally, the insertion hole (not shown) for receiving the shaft (not shown) is formed on each of the one end edge of the aforementioned underlay board 51 and the one end edge of the aforementioned input device A. The shaft is inserted through the insertion holes. Thus, the aforementioned input device A and the aforementioned underlay board 51 are assembled pivotably relative to each other about the one end edges thereof. In this manner, the aforementioned underlay-board-equipped input device is produced.

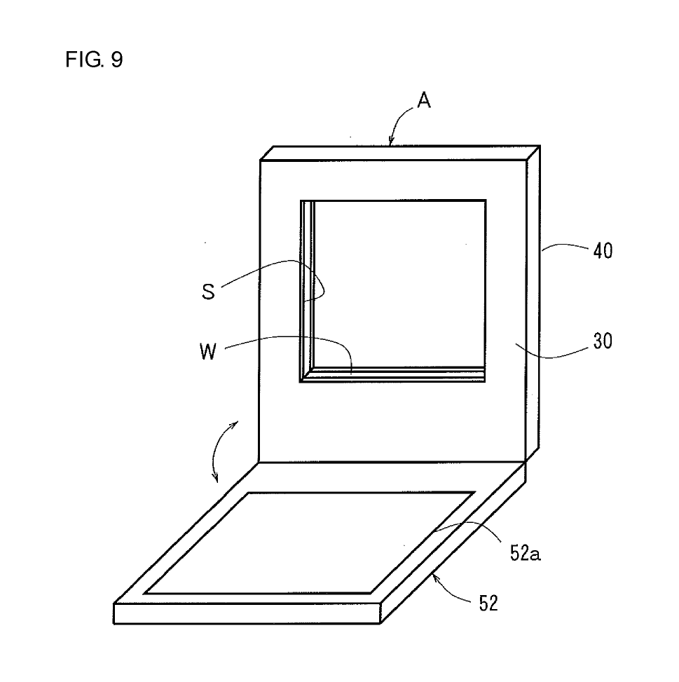

FIG. 9 is a perspective view showing a second preferred embodiment of the underlay-board-equipped input device according to the first aspect. In the underlay-board-equipped input device of this preferred embodiment, the means for positioning the writing paper sheet 70 (with reference to FIG. 1) on the front surface of an underlay board 52 includes mark lines 52a marked on the front surface of the underlay board 52 and indicating the outer periphery of the writing paper sheet 70, in place of the protrusions 51a (with reference to FIG. 1) of the aforementioned first preferred embodiment. Thus, the insertion holes 31 (with reference to FIG. 1) for receiving the aforementioned protrusions 51a are not formed in the back surface of the input device A. The region surrounded by the aforementioned mark lines 52a (the region of the writing paper sheet 70) is larger than the region of the hollow input-use interior S of the input device A, so that a peripheral portion of the writing paper sheet 70 positioned outside the region of the hollow input-use interior S is held between the front surface of the underlay board 52 and the back surface of the peripheral portion of the hollow input-use interior S of the input device A. Other parts of the second preferred embodiment are similar to those of the aforementioned first preferred embodiment, and like reference numerals and characters are used to designate the similar parts.

For setting the writing paper sheet 70 on the underlay-board-equipped input device in this preferred embodiment, the input device A and the underlay board 52 are pivoted relative to each other into an open condition, and the writing paper sheet 70 is thereafter placed so that the outer periphery of the writing paper sheet 70 is along the aforementioned mark lines 52a. This placement allows the proper positioning of the aforementioned writing paper sheet 70. Next, the input device A and the underlay board 52 are pivoted relative to each other into a closed condition. Accordingly, a portion of the writing paper sheet 70 positioned outside the region of the hollow input-use interior S is held between the front surface of the underlay board 52 and the back surface of the input device A, so that the writing paper sheet 70 is fixed. Thus, when the user writes on the writing paper sheet 70 in this state, the writing paper sheet 70 is not displaced in position. When the writing paper sheet 70 is removed from the aforementioned underlay-board-equipped input device and is set thereon again, the writing paper sheet 70 is placed in the same position as last time, and is not displaced in position.

The aforementioned mark lines 52a in the second preferred embodiment may be formed by painting with a paint, by printing or by grooves. Although the aforementioned mark lines 52a are shown in the shape of a rectangle in FIG. 9, only the four corners of the rectangle may be marked.

The aforementioned writing paper sheet 70 used in this second preferred embodiment may be a writing paper sheet 70 similar to that of the aforementioned first preferred embodiment in which the through holes 71 are formed, or may be a typical writing paper sheet 70 in which the through holes 71 are not formed.

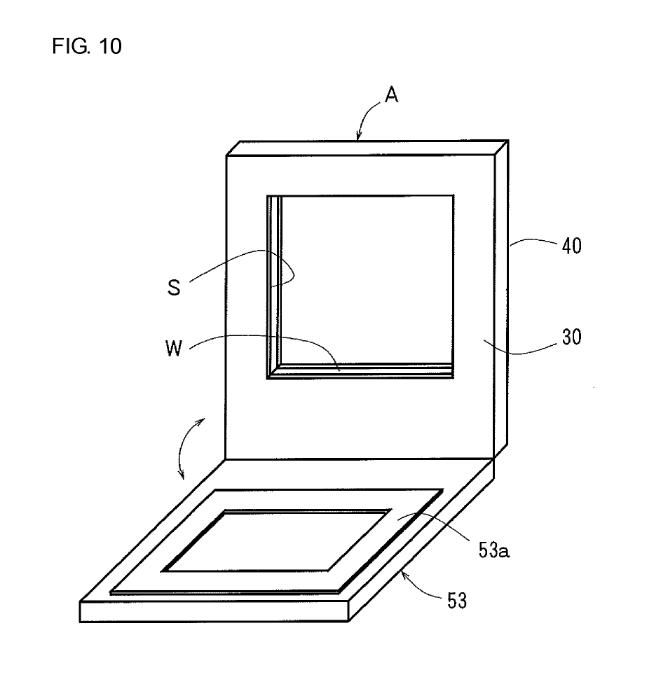

FIG. 10 is a perspective view showing a third preferred embodiment of the underlay-board-equipped input device according to the first aspect. In the underlay-board-equipped input device of this preferred embodiment, the means for positioning the writing paper sheet 70 (with reference to FIG. 1) on the front surface of an underlay board 53 includes a rectangular frame-shaped anti-slip member 53a disposed on the front surface of the underlay board 53 in corresponding relation to the outer periphery of the writing paper sheet 70, in place of the mark lines 52a (with reference to FIG. 9) of the underlay board 52 of the second preferred embodiment. The region surrounded by the outer edges of the rectangular frame-shaped anti-slip member 53a (the region of the writing paper sheet 70) is larger than the region of the hollow input-use interior S of the input device A as in the aforementioned second preferred embodiment, so that a peripheral portion of the writing paper sheet 70 positioned outside the region of the hollow input-use interior S is held between the front surface of the underlay board 53 and the back surface of the peripheral portion of the hollow input-use interior S of the input device A. Thus, the aforementioned anti-slip member 53a makes it more difficult for the writing paper sheet 70 to be displaced in position. Other parts of the third preferred embodiment are similar to those of the aforementioned second preferred embodiment, and like reference numerals and characters are used to designate the similar parts.

Although the aforementioned anti-slip member 53a is disposed in the shape of a rectangular frame in this third preferred embodiment, the anti-slip member 53a may be disposed in a rectangular shape identical with that of the writing paper sheet 70.

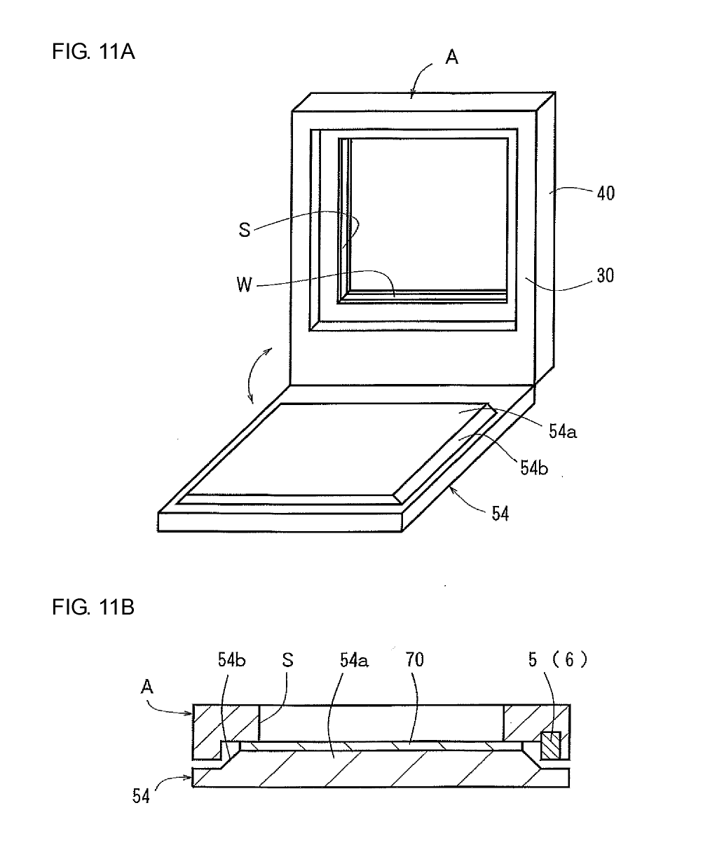

FIG. 11A is a perspective view showing a fourth preferred embodiment of the underlay-board-equipped input device according to the first aspect. FIG. 11B is a sectional view of the underlay-board-equipped input device which is closed to hold the writing paper sheet 70 between components thereof. In the underlay-board-equipped input device in this preferred embodiment, the means for positioning the writing paper sheet 70 on the front surface of an underlay board 54 includes a raised region which is to be surrounded by the mark lines 52a (a portion for placement of the writing paper sheet 70 thereon), in place of the mark lines 52a (with reference to FIG. 9) of the aforementioned second preferred embodiment. The raised portion on the front surface of the underlay board 54 is a mounting table 54a for placing the writing paper sheet 70 thereon. The mounting table 54a has outer peripheral side surfaces 54b formed as inclined surfaces. The upper end edges of the respective outer peripheral side surfaces 54b correspond to the outer periphery of the writing paper sheet 70. The mounting table 54a which is raised in this manner allows the user to recognize the outer peripheral side surfaces 54b of the mounting table 54a by touching with a hand or a finger, thereby facilitating the positioning of the writing paper sheet 70. The input device A is configured so that the retainer plate 30 at the bottom has a step portion for surrounding the aforementioned mounting table 54a when the underlay-board-equipped input device is in a closed condition. Other parts of the fourth preferred embodiment are similar to those of the aforementioned second preferred embodiment, and like reference numerals and characters are used to designate the similar parts.

In the fourth preferred embodiment, as shown in FIG. 11B, the step portion of the input device A may be used to arrange the light-emitting element 5, the light-receiving element 6 and the like constituting the input device A in a position shifted to a lower step portion of the aforementioned step portion. This arrangement prevents the underlay-board-equipped input device in a closed condition from becoming so thick even when the mounting table 54a is formed.

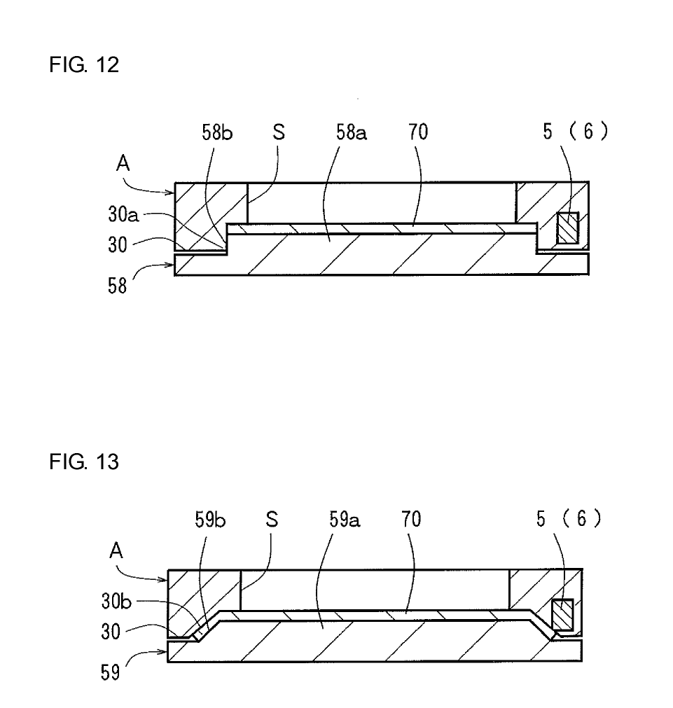

FIG. 12 shows a fifth preferred embodiment of the underlay-board-equipped input device according to the first aspect, and is a sectional view of the underlay-board-equipped input device which is closed to hold the writing paper sheet 70 between components thereof. The underlay-board-equipped input device of this preferred embodiment is such that a mounting table 58a formed on an underlay board 58 has outer peripheral side surfaces 58b which are in a standing position perpendicular to the aforementioned underlay board 58 in the aforementioned fourth preferred embodiment (with reference to FIGS. 11A and 11B). The retainer plate 30 at the bottom in the input device A has a step portion 30a corresponding to the outer peripheral shape of the mounting table 58a. This facilitates the fixing of the writing paper sheet 70, with the aforementioned writing paper sheet 70 positioned. Other parts of the fifth preferred embodiment are similar to those of the aforementioned fourth preferred embodiment, and like reference numerals and characters are used to designate the similar parts.

FIG. 13 shows a sixth preferred embodiment of the underlay-board-equipped input device according to the first aspect, and is a sectional view of the underlay-board-equipped input device which is closed to hold the writing paper sheet 70 between components thereof. The underlay-board-equipped input device of this preferred embodiment includes an underlay board 59 having a mounting table 59a in a manner similar to that in the aforementioned fourth preferred embodiment (with reference to FIGS. 11A and 11B). The retainer plate 30 at the bottom in the input device A has an inclined portion 30b corresponding to the inclined outer peripheral shape of the mounting table 59a. In this preferred embodiment, the aforementioned mounting table 59a has outer peripheral side surfaces 59b, and the lower end edges of the respective outer peripheral side surfaces 59b correspond to the outer periphery of the writing paper sheet 70. Thus, when the underlay-board-equipped input device is in a closed condition (or holds the writing paper sheet 70 between components thereof), an outer peripheral portion of the writing paper sheet 70 is pulled outwardly by abutting against the inclined portion 30b of the retainer plate 30 at the bottom in the input device A. This allows part of the writing paper sheet 70 lying on the mounting table 59a to be in a flat condition free of wrinkles and slack. This flat condition prevents errors such that the light beams H (with reference to FIG. 3A) traveling in a lattice form within the hollow input-use interior S are intercepted by the wrinkles and slack parts of the aforementioned writing paper sheet 70.

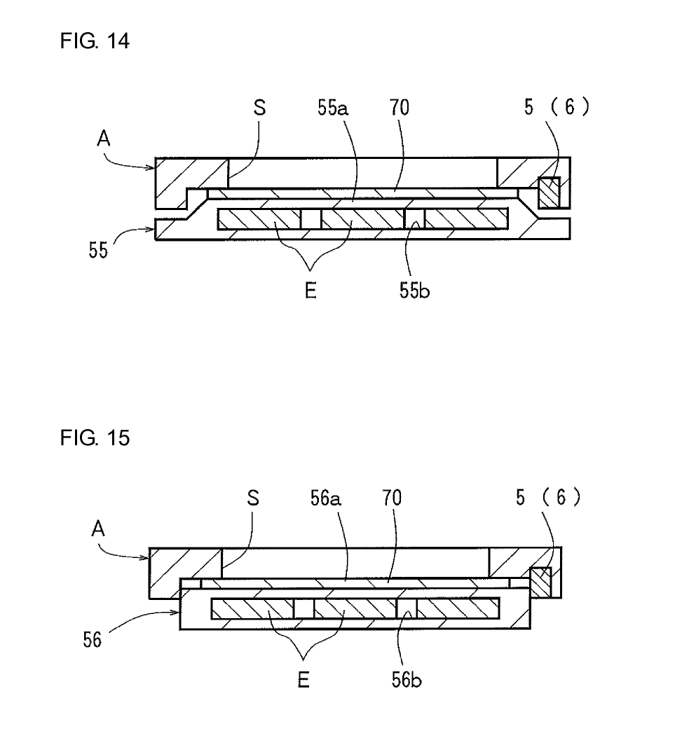

FIG. 14 shows a seventh preferred embodiment of the underlay-board-equipped input device according to the first aspect, and is a sectional view of the underlay-board-equipped input device which is closed to hold the writing paper sheet 70 between components thereof. In the underlay-board-equipped input device of this preferred embodiment, an underlay board 55 includes a mounting table 55a in a manner similar to that in the aforementioned fourth preferred embodiment (with reference to FIGS. 11A and 11B), and an accommodating portion 55b for accommodating batteries E for driving the input device A is formed inside a thick part formed by the mounting table 55a. The formation of the accommodating portion 55b achieves the effective use of the inside of the aforementioned mounting table 55a as a place to install the aforementioned driving batteries E which are thick and constitute the input device A. This reduces the thickness of the underlay-board-equipped input device in a closed condition. Other parts of the seventh preferred embodiment are similar to those of the aforementioned fourth preferred embodiment, and like reference numerals and characters are used to designate the similar parts.

FIG. 15 shows an eighth preferred embodiment of the underlay-board-equipped input device according to the first aspect, and is a sectional view of the underlay-board-equipped input device which is closed to hold the writing paper sheet 70 between components thereof. In the underlay-board-equipped input device of this preferred embodiment, the whole of an underlay board 56 is in the form of a mounting table 56a for placing the writing paper sheet 70 thereon, and an accommodating portion 56b for the batteries E is entirely formed inside the underlay board 56. This allows the underlay board 56 to be entirely accommodated inside the outer frame of the input device A when the underlay-board-equipped input device is in a closed condition. This reduces the thickness of the underlay-board-equipped input device in a manner similar to that in the aforementioned seventh preferred embodiment (with reference to FIG. 14). Other parts of the eighth preferred embodiment are similar to those of the aforementioned seventh preferred embodiment, and like reference numerals and characters are used to designate the similar parts.

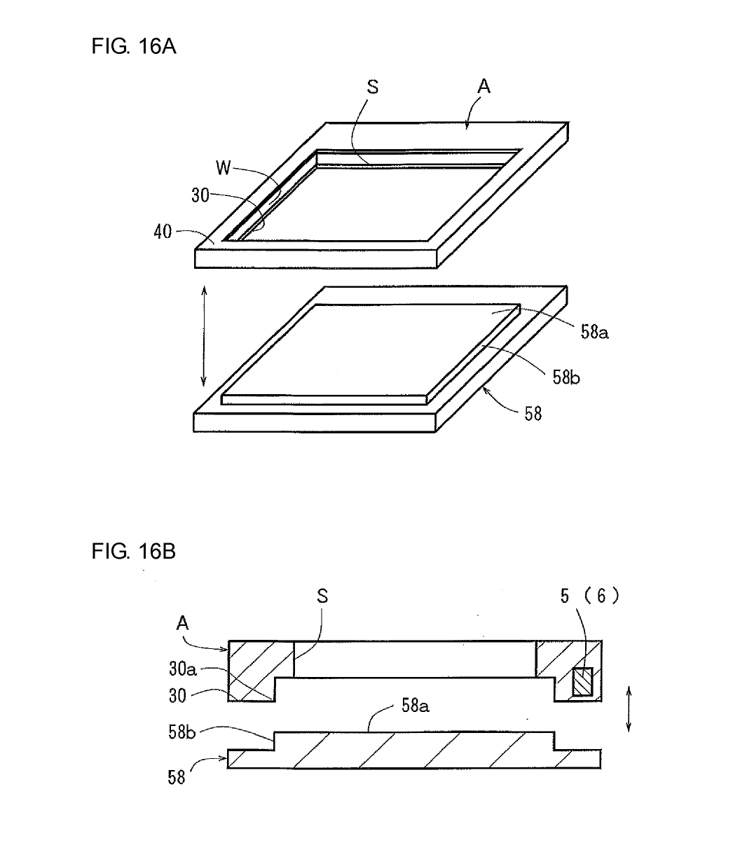

FIG. 16A is a perspective view showing a ninth preferred embodiment of the underlay-board-equipped input device according to a second aspect, and FIG. 16B is a sectional view thereof. The underlay-board-equipped input device of this preferred embodiment is such that the input device A and the underlay board 58 are not integral with each other pivotably about the one end edges thereof but are configured to removably engage each other in the aforementioned fifth preferred embodiment (with reference to FIG. 12). Specifically, the removable engagement between the aforementioned input device A and the underlay board 58 is achieved by the removable engagement between the peripheral portion of the mounting table 58a formed on the aforementioned underlay board 58 and the step portion 30a formed in the retainer plate 30 at the bottom in the aforementioned input device A. The aforementioned engagement prevents the input device A and the underlay board 58 from being displaced in position relative to each other, and allows the writing paper sheet 70 (with reference to FIG. 12) to be fixed while being positioned in a manner similar to that in the aforementioned fifth preferred embodiment. Other parts of the ninth preferred embodiment are similar to those of the aforementioned fifth preferred embodiment, and like reference numerals and characters are used to designate the similar parts.

A modification of this preferred embodiment may be made in which the input device A and the underlay board 59 similar to those in the aforementioned sixth preferred embodiment (with reference to FIG. 13) are used. Specifically, the outer peripheral side surfaces 59b of the mounting table 59a formed on the underlay board 59 may be inclined, and the inclined portion 30b corresponding to the inclination of the outer peripheral side surfaces 59b may be formed in the retainer plate 30 at the bottom in the input device A. Then, the writing paper sheet 70 is fixed in a manner similar to that in the aforementioned sixth preferred embodiment.

Other modifications of this preferred embodiment may be made in which the input device A and the underlay boards 55 and 56 similar to those in the aforementioned seventh and eighth preferred embodiments (with reference to FIGS. 14 and 15) are used. Specifically, the accommodating portions 55b and 56b for accommodating the driving batteries E may be formed inside the mounting tables 55a and 56a formed on the underlay boards 55 and 56, respectively.

In the above preferred embodiments, a rubber material which is less slippery on the writing paper sheet 70 may be used for part of the input device A which contacts the writing paper sheet 70.

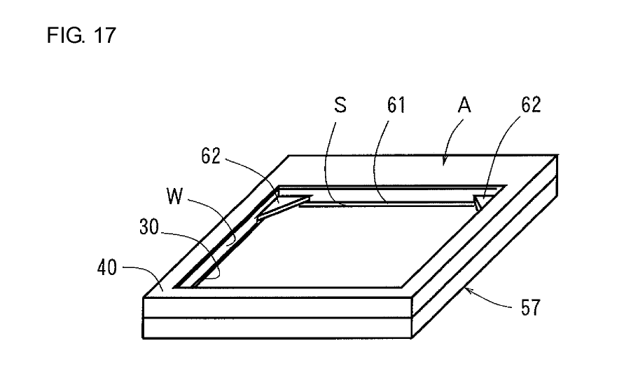

FIG. 17 is a perspective view showing a tenth preferred embodiment of the underlay-board-equipped input device according to a third aspect. In the underlay-board-equipped input device of this preferred embodiment, an underlay board 57 in a multi-layer condition is fixed on the back surface of the rectangular frame-shaped input device A having the rectangular hollow input-use interior S. One side of the inner peripheral edges of the hollow input-use interior S of the input device A serves as a positioning reference side 61 for the positioning of one side of the outer peripheral edges of the writing paper sheet 70 (with reference to FIG. 1). Fixed pieces 62 made of resin, metal and the like are provided at corners lying on opposite ends of the positioning reference side 61 by bonding using an adhesive and the like. Two adjacent corners of the aforementioned writing paper sheet 70 are held between the back surface of the fixed pieces 62 and the front surface of the aforementioned underlay board 57. The front surface of the underlay board 57 is planar. Other parts of the tenth preferred embodiment are similar to those of the aforementioned first preferred embodiment, and like reference numerals and characters are used to designate the similar parts.

For setting the writing paper sheet 70 on the underlay-board-equipped input device in this preferred embodiment, two adjacent corners of the writing paper sheet 70 are slid in between the two fixed pieces 62 in the hollow input-use interior S and the underlay board 57, and the one side lying between the aforementioned two corners of the writing paper sheet 70 is brought into abutment against the one side (the positioning reference side 61) lying between the aforementioned two fixed pieces 62 in the hollow input-use interior S. This abutment causes the aforementioned two corners of the writing paper sheet 70 to be held between the back surface of the fixed pieces 62 and the front surface of the aforementioned underlay board 57, thereby fixing the writing paper sheet 70. The one side of the writing paper sheet 70 abuts against the positioning reference side 61 in the hollow input-use interior S, whereby the writing paper sheet 70 is positioned properly. The writing paper sheet 70 is not displaced in position when the user writes on the writing paper sheet 70 in this state. For the removal of the writing paper sheet 70, the aforementioned two corners of the writing paper sheet 70 are pulled out from between the back surface of the fixed pieces 62 and the front surface of the aforementioned underlay board 57, so that the writing paper sheet 70 is removed. For setting the writing paper sheet 70 again, the writing paper sheet 70 which is set in a manner similar to that described above is placed in the same position as last time, and is not displaced in position.

For the purpose of improving the light transmission efficiency within the hollow input-use interior S of the rectangular frame-shaped optical waveguide W of the input device A according to the aforementioned preferred embodiments, the tips of the light-emitting cores 2a and the tips of the light-receiving cores 2b are formed as the lens portions, and the edge portion of the over cladding layer 3 covering the lens portions of the cores 2a and 2b is formed as the lens portion 3a. However, when the light transmission efficiency within the hollow input-use interior S is sufficient, the aforementioned lens portion(s) may be formed only in either the cores 2a and 2b or the over cladding layer 3, or be formed in neither the cores 2a and 2b nor the over cladding layer 3. When the aforementioned lens portions are not formed, a separate lens element may be prepared and provided along the periphery within the hollow input-use interior S of the aforementioned optical waveguide W.

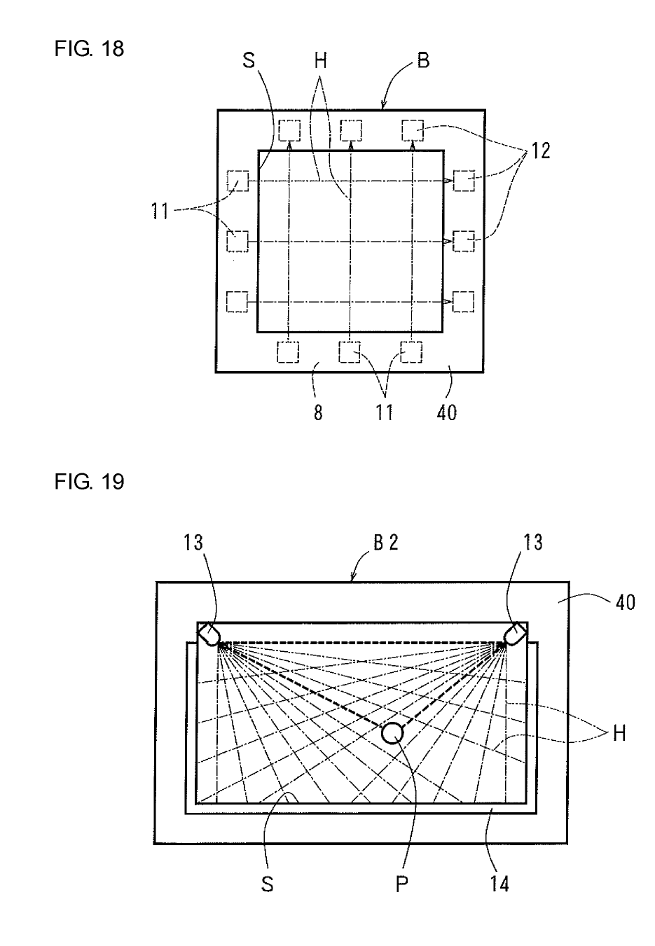

FIG. 18 shows another preferred embodiment of part of the input device according to the above preferred embodiments. An input device B according to this preferred embodiment includes: a rectangular frame-shaped retainer plate having the rectangular hollow input-use interior S; light-emitting diodes (light-emitting means) 11 disposed in juxtaposition on one of opposed peripheral sections of the retainer plate around the aforementioned hollow input-use interior S; and photodiodes (light-receiving means) 12 disposed in juxtaposition on the other peripheral section of the retainer plate. Light-emitting sections of the aforementioned light-emitting diodes 11 are opposed to light-receiving sections of the aforementioned photodiodes 12. The optical waveguide W (with reference to FIGS. 3A and 3B) is not provided in the input device B. It should be noted that the aforementioned light-emitting diodes 11 and the photodiodes 12 are mounted on the rectangular frame-shaped circuit board 8 provided on the front surface of the aforementioned retainer plate. As in the aforementioned first preferred embodiment, a CPU for controlling the input device B, an output module for outputting information inputted into the region within the aforementioned hollow input-use interior S, a storage means, a battery, and the like are mounted on the aforementioned circuit board 8. Further, the protective plate 40 is also provided. In FIG. 18, the number of light-emitting diodes 11 and the number of photodiodes 12 are shown as abbreviated.

Also in this preferred embodiment, the aforementioned light-emitting diodes 11 cause light beams H to travel in a lattice form in the region within the aforementioned hollow input-use interior S. When the pen P (with reference to FIG. 2) is moved in the region within the hollow input-use interior S, some of the light beams H traveling in the aforementioned lattice form are intercepted by the pen tip of the aforementioned pen P. The aforementioned photodiodes 12 sense the interception of light beams to thereby detect the path of the aforementioned pen tip. In other words, the input device B according to this preferred embodiment may be used in place of the input device A of the aforementioned first to tenth preferred embodiments.

FIG. 19 shows still another preferred embodiment of part of the input device according to the aforementioned first to tenth preferred embodiments. An input device B2 according to this preferred embodiment is configured such that measuring modules 13 are provided on corners of a rectangular frame-shaped retainer plate having the rectangular hollow input-use interior S, the corners being on opposite ends of one side of the aforementioned hollow input-use interior S, and each include a light-emitting diode (a light-emitting means) and a CMOS image sensor (a light-receiving means) which are stacked vertically (in a direction orthogonal to the aforementioned retainer plate), and such that a retroreflective tape 14 is affixed to the inner side surface of the remaining three sides. The aforementioned light-emitting diodes project light beams H at a divergence angle of approximately 90°, and cause the light beams H to travel throughout the aforementioned hollow input-use interior S. The aforementioned retroreflective tape 14 has the function of reflecting incoming light in the same direction. The aforementioned two measuring modules 13 are mounted on a circuit board provided on part of the front surface of the aforementioned retainer plate.

In this preferred embodiment, light beams projected from the light-emitting diode of each of the aforementioned measuring modules 13 are reflected from the aforementioned retroreflective tape 14 and then received by the CMOS image sensor of each measuring module 13 from which the light beams are projected. Thus, the light beams H travel in a fan-like form from the aforementioned two measuring modules 13 within the aforementioned hollow input-use interior S. When the pen P is moved in the region within the hollow input-use interior S, some of the light beams H traveling in the aforementioned fan-like form are intercepted by the pen tip of the aforementioned pen P. The CMOS image sensors of the aforementioned two measuring modules 13 sense the interception of light beams. The position of the interception of light beams (the position of the aforementioned pen tip) is specified using triangulation. In other words, the input device B2 according to this preferred embodiment may be used in place of the input device A of the aforementioned first to tenth preferred embodiments.

In the aforementioned preferred embodiments, the underlay-board-equipped input device is used together with a PC, and the information inputted to the aforementioned input devices A, B and B2 is displayed on a display for the aforementioned PC. Alternatively, functionality similar to that of the PC in the aforementioned preferred embodiments may be imparted to the aforementioned input devices A, B and B2 or to the aforementioned display, so that information is displayed on the display without using the PC.

Additionally, a means for attracting the writing paper sheet 70 by suction may be provided on a surface of each of the underlay boards 51 to 59 which contacts the writing paper sheet 70 in the aforementioned preferred embodiments. Examples of the means include an electrostatic chuck scheme, an air suction scheme, and a slightly-adhesive silicone sheet.

Next, examples of the present invention will be described. It should be noted that the present invention is not limited to the examples.

### EXAMPLES

### Example 1

### Production of Underlay Board

An underlay board having a plurality of cylindrical protrusions formed thereon as shown in FIG. 1 was produced by preparing an aluminum plate as a material for the formation of the underlay board and then cutting the aluminum plate. The aforementioned protrusions had an outside diameter of 5 mm and a height of 5 mm.

### <Material for Formation of Under Cladding Layer>

Component A: 75 parts by weight of an epoxy resin containing an alicyclic skeleton (EHPE 3150 manufactured by Daicel Chemical Industries, Ltd.).

Component B: 25 parts by weight of an epoxy-group-containing acrylic polymer (MARPROOF G-0150M manufactured by NOF Corporation).

Component C: four parts by weight of a photo-acid generator (CPI-200K manufactured by San-Apro Ltd.).

A material for the formation of an under cladding layer was prepared by dissolving these components A to C together with five parts by weight of an ultraviolet absorber (TINUVIN 479 manufactured by Ciba Japan K.K.) in cyclohexanone (a solvent).

### <Material for Formation of Cores>

Component D: 85 parts by weight of an epoxy resin containing a bisphenol A skeleton (157S70 manufactured by Japan Epoxy Resins Co., Ltd.).

Component E: five parts by weight of an epoxy resin containing a bisphenol A skeleton (Epikote 828 manufactured by Japan Epoxy Resins Co., Ltd.).

Component F: 10 parts by weight of an epoxy-group-containing styrenic polymer (MARPROOF G-0250SP manufactured by NOF Corporation).

A material for the formation of cores was prepared by dissolving these components D to F and four parts by weight of the aforementioned component C in ethyl lactate.

### <Material for Formation of Over Cladding Layer>

Component G: 100 parts by weight of an epoxy resin having an alicyclic skeleton (EP4080E manufactured by ADEKA Corporation).

A material for the formation of an over cladding layer was prepared by mixing this component G and two parts by weight of the aforementioned component C together.

### <Production of Optical Waveguide>

The aforementioned material for the formation of the under cladding layer was applied to a surface of a substrate made of stainless steel (having a thickness of 50 μm). Thereafter, a heating treatment was performed at 160° C. for two minutes to form a photosensitive resin layer. Then, the aforementioned photosensitive resin layer was exposed to irradiation with ultraviolet light at an integrated dose of 1000 mJ/cm². Thus, the under cladding layer having a thickness of 10 μm (with a refractive index of 1.510 at a wavelength of 830 nm) was formed.

Then, the aforementioned material for the formation of the cores was applied to a surface of the aforementioned under cladding layer. Thereafter, a heating treatment was performed at 170° C. for three minutes to form a photosensitive resin layer. Next, exposure to irradiation with ultraviolet light at an integrated dose of 3000 mJ/cm² was performed through a photomask (with a gap of 100 μm). Subsequently, a heating treatment was performed at 120° C. for 10 minutes. Thereafter, development was performed using a developing solution (γ-butyrolactone) to dissolve away unexposed portions. Thereafter, a drying process was performed at 120° C. for five minutes. Thus, the cores having a width of 30 μm and a height of 50 μm (with a refractive index of 1.570 at a wavelength of 830 nm) were patterned.

A light-transmissive mold for the formation of the over cladding layer was prepared. This mold includes a cavity having a mold surface complementary in shape to the surface of the over cladding layer. The mold was placed on a molding stage, with the cavity positioned to face upward. Then, the cavity was filled with the aforementioned material for the formation of the over cladding layer.

Then, the cores patterned on the surface of the aforementioned under cladding layer were positioned relative to the cavity of the aforementioned mold. In that state, the aforementioned under cladding layer was pressed against the aforementioned mold, so that the aforementioned cores were immersed in the aforementioned material for the formation of the over cladding layer. In this state, exposure was performed at an integrated dose of 8000 mJ/cm² by irradiating the aforementioned material for the formation of the over cladding layer with ultraviolet light through the aforementioned mold. Thus, the over cladding layer was formed in which a portion thereof corresponding to the tips of the cores was in the form of a convex lens portion. The convex lens portion had a substantially quadrantal curved lens surface (having a radius of curvature of 1.4 mm) as seen in sectional side view.

Next, the aforementioned over cladding layer together with the aforementioned substrate, the under cladding layer and the cores was removed from the aforementioned mold.

Then, the aforementioned substrate was stripped from the under cladding layer. This provided each strip-shaped optical waveguide section (having a total thickness of 1 mm) including the under cladding layer, the cores, and the over cladding layer.

### <Production of Input Device>

Next, a circuit board was prepared, and a control means was produced by mounting a light-emitting element (SM85-2N001 manufactured by Optowell Co., Ltd.), a light-receiving element (S-10226 manufactured by Hamamatsu Photonics K.K.), a CMOS driving CPU, a crystal oscillator, a wireless module, a lithium-ion battery (3.7 V) and the like onto the circuit board.

A rectangular frame-shaped retainer plate made of stainless steel (having a thickness of 0.50 mm) was prepared. The retainer plate had a hollow input-use interior in the form of a rectangle that was 30 cm in length and 30 cm in width. Then, insertion holes for receiving the protrusions of the aforementioned underlay board were formed in the back surface of the aforementioned retainer plate by electro-discharge machining. The insertion holes had an inside diameter of 5.5 mm. The aforementioned strip-shaped optical waveguide sections were affixed to a portion of the front surface of the aforementioned retainer plate which was outside the aforementioned hollow input-use interior to produce a rectangular frame-shaped optical waveguide, and the aforementioned control means was fixed thereon. At this time, the aforementioned light-emitting element was connected to light-emitting ones of the cores, and the aforementioned light-receiving element was connected to light-receiving ones of the cores. Thereafter, the top surface of the aforementioned over cladding layer except the lens portion and the fixed portion of the aforementioned control means were covered with a rectangular frame-shaped protective plate made of stainless steel (having a thickness of 0.5 mm). This provided an input device shown in FIG. 1.

### <Production of Underlay-Board-Equipped Input Device>

Finally, insertion holes for receiving a shaft were formed on one end edge of the aforementioned underlay board and one end edge of the aforementioned input device, and the shaft was inserted through the insertion holes. Thus, the aforementioned input device and the aforementioned underlay board were assembled together pivotably about the one end edges thereof relative to each other. This provided an underlay-board-equipped input device shown in FIG. 1.

### Example 2

### Production of Input Device

A rectangular frame-shaped retainer plate similar to that in Example 1 described above was formed. Light-emitting diodes (GL4800E0000F manufactured by Sharp Corporation) were disposed in juxtaposition on one of opposed peripheral sections of the retainer plate around the hollow input-use interior, and photodiodes (PD411PI2E00P manufactured by Sharp Corporation) were disposed in juxtaposition on the other peripheral section of the retainer plate. Also, in a manner similar to that in Example 1 described above, a control means was produced by mounting a CMOS driving CPU, a crystal oscillator, a wireless module, two coin-type lithium cells and the like onto a circuit board, and the control means was fixed on the aforementioned retainer plate. The aforementioned light-emitting diodes, the photodiodes and the control means were covered with a rectangular frame-shaped protective plate made of stainless steel (having a thickness of 0.5 mm). This provided an input device shown in FIG. 18.

### <Production of Underlay-Board-Equipped Input Device>

An underlay board similar to that in Example 1 described above was formed. The underlay board and the aforementioned input device were assembled together pivotably in a manner similar to that in Example 1 described above. This provided an underlay-board-equipped input device.

### <Operation Check of Input Device>

A USB memory device with information such as a document stored therein, and a PC were prepared. The information stored in the USB memory device was displayed on a display for the PC by the use of the aforementioned PC. Software (a program) for converting coordinates in the region within the rectangular frame-shaped hollow input-use interior of the aforementioned input device into coordinates on the screen of the display to display a character or the like inputted by means of the input device on the display is incorporated in the aforementioned PC. The aforementioned PC included a receiving means so as to be able to receive radio waves (information) from the wireless module of the aforementioned input device. The aforementioned PC and the input device were connected for transmission of information therebetween by radio.

A writing paper sheet such that through holes were formed in one end edge portion thereof was prepared. Next, the underlay-board-equipped input device in each of Examples 1 and 2 described above was put in an open condition. The protrusions of the aforementioned underlay board were inserted through the through holes of the aforementioned writing paper sheet, and the aforementioned writing paper sheet was placed on the front surface of the aforementioned underlay board. Thereafter, the aforementioned underlay-board-equipped input device was put in a closed condition, so that a portion of the aforementioned writing paper sheet around the through holes was held between a portion of the front surface of the aforementioned underlay board around the protrusions and a portion of the back surface of the aforementioned input device around the insertion holes, whereby the aforementioned writing paper sheet was fixed. Then, a character was written with a pen on the aforementioned writing paper sheet revealed in a region within the aforementioned hollow input-use interior. The result was that the character was displayed while being superimposed on the information such as a document appearing on the aforementioned display, and the aforementioned writing paper sheet was not displaced in position. The aforementioned underlay-board-equipped input device was put in an open condition, and the aforementioned writing paper sheet was removed. Thereafter, the aforementioned writing paper sheet was set again on the aforementioned underlay-board-equipped input device in a manner similar to that described above, and a character was written with a pen on the aforementioned writing paper sheet revealed in the region within the aforementioned hollow input-use interior. The result was that there arose no positional displacement of the information written on the aforementioned writing paper sheet and the information appearing on the aforementioned display.

Also, a result similar to that in Example 1 described above was attained when underlay-board-equipped input devices shown in FIGS. 9, 10, 11A, 11B, 12, 13, 14, 15, 16A, 16B and 17 were produced and used. Further, a result similar to that in Example 2 described above was attained when input devices corresponding to the underlay boards shown in FIGS. 9, 10, 11A, 11B, 12, 13, 14, 15, 16A, 16B and 17 were produced and underlay-board-equipped input devices to which the input devices were mounted were used.

The underlay-board-equipped input device according to the present invention is applicable to holding and fixing a writing paper sheet between the underlay board and the input device and displaying new information such as characters, drawings, marks and the like written on the writing paper sheet on a display.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. An underlay-board-equipped input device, comprising:
an input device including a frame-shaped plate having the shape of a frame surrounding a space serving as a hollow input-use interior, a light-emitting means provided on one of a pair of opposed sections of the frame-shaped plate, and a light-receiving means provided on the other of the opposed sections of the frame-shaped plate and for receiving light beams emitted from the light-emitting means; and
an underlay board pivotably mounted to a back surface of the input device about one end edge of the input device,
wherein the underlay board includes a means for positioning a writing paper sheet on a front surface of the underlay board, and
wherein the front surface of the underlay board and a back surface of the input device are configured to form a holding part for holding the writing paper sheet therebetween.

2. The underlay-board-equipped input device according to claim 1, wherein the means for positioning the writing paper sheet includes a plurality of protrusions for insertion through a plurality of through holes previously formed in the writing paper sheet.

3. The underlay-board-equipped input device according to claim 1, wherein the means for positioning the writing paper sheet includes mark lines indicating the outer periphery of the writing paper sheet.

4. The underlay-board-equipped input device according to claim 1, wherein the means for positioning the writing paper sheet includes an anti-slip member disposed in corresponding relation to the outer periphery of the writing paper sheet.

5. The underlay-board-equipped input device according to claim 1, wherein the means for positioning the writing paper sheet includes a mounting table for placing the writing paper sheet thereon and having an outer peripheral side surface corresponding to the outer periphery of the writing paper sheet.

6. The underlay-board-equipped input device according to claim 5, wherein an accommodating portion for accommodating a battery for driving the input device is formed inside a part of the underlay board where the mounting table is formed.

7. An underlay-board-equipped input device, comprising:
an input device including a frame-shaped plate having the shape of a frame surrounding a space serving as a hollow input-use interior, a light-emitting means provided on one of a pair of opposed sections of the frame-shaped plate, and a light-receiving means provided on the other of the opposed sections of the frame-shaped plate and for receiving light beams emitted from the light-emitting means; and
an underlay board removably engagable to the back surface of the input device,
wherein the underlay board includes a mounting table formed on a front surface of the underlay board and for placing a writing paper sheet thereon,
wherein part of a back surface of the input device corresponding to a peripheral portion of the mounting table is formed in a shape corresponding to a peripheral portion of the mounting table,
wherein the peripheral portion of the mounting table and the part of the back surface of the input device are removably engageable with each other,
wherein the mounting table has an outer peripheral side surface corresponding to the outer periphery of the writing paper sheet, and
wherein the peripheral portion of the mounting table and the back surface of the input device form a holding part for holding the writing paper sheet therebetween.

8. An underlay-board-equipped input device, comprising:
an input device including a frame-shaped plate having the shape of a frame surrounding a space serving as a hollow input-use interior, a light-emitting means provided on one of a pair of opposed sections of the frame-shaped plate, and a light-receiving means provided on the other of the opposed sections of the frame-shaped plate and for receiving light beams emitted from the light-emitting means; and
an underlay board fixed to a back surface of the input device,
wherein one side of inner peripheral edges of the hollow input-use interior is formed as a positioning reference side for positioning one side of outer peripheral edges of a writing paper sheet,
wherein fixed pieces are provided at corners lying on opposite ends of the positioning reference side, and
wherein back surfaces of the fixed pieces and a front surface of the underlay board form a part for holding two adjacent corners of the writing paper sheet therebetween.

9. The underlay-board-equipped input device according to claim 1,
wherein the light-emitting means includes a light-emitting element, and a plurality of light-emitting cores of an optical waveguide, the light-emitting cores being connected to the light-emitting element;
wherein the light-receiving means includes a light-receiving element, and a plurality of light-receiving cores of the optical waveguide, the light-receiving cores being connected to the light-receiving element; and
wherein tips of the light-emitting cores and tips of the light-receiving cores are opposed to each other while being positioned on inner edges of the frame-shaped plate.

10. The underlay-board-equipped input device according to claim 1,
wherein the light-emitting means includes a plurality of light-emitting elements;
wherein the light-receiving means includes a plurality of light-receiving elements; and
wherein the light-emitting elements and the light-receiving elements are opposed to each other while being positioned on inner edges of the frame-shaped plate.

11. The underlay-board-equipped input device according to claim 1,
wherein the light-emitting means and the light-receiving means include two modules disposed on respective corners lying on opposite ends of one side of the frame-shaped plate, each of the two modules including a light-emitting element and a light-receiving element which are stacked vertically;
wherein a retroreflector in the form of a tape is affixed to inner side surface of three sides other than the one side lying between the modules; and
wherein light beams projected from the light-emitting element of one of the modules are reflected from the retroreflector and are then received by the light-receiving element of the one module.

12. The underlay-board-equipped input device according to claim 7,
wherein the light-emitting means includes a light-emitting element, and a plurality of light-emitting cores of an optical waveguide, the light-emitting cores being connected to the light-emitting element;
wherein the light-receiving means includes a light-receiving element, and a plurality of light-receiving cores of the optical waveguide, the light-receiving cores being connected to the light-receiving element; and
wherein tips of the light-emitting cores and tips of the light-receiving cores are opposed to each other while being positioned on inner edges of the frame-shaped plate.

13. The underlay-board-equipped input device according to claim 8,
wherein the light-emitting means includes a light-emitting element, and a plurality of light-emitting cores of an optical waveguide, the light-emitting cores being connected to the light-emitting element;
wherein the light-receiving means includes a light-receiving element, and a plurality of light-receiving cores of the optical waveguide, the light-receiving cores being connected to the light-receiving element; and
wherein tips of the light-emitting cores and tips of the light-receiving cores are opposed to each other while being positioned on inner edges of the frame-shaped plate.

14. The underlay-board-equipped input device according to claim 7,
wherein the light-emitting means includes a plurality of light-emitting elements;
wherein the light-receiving means includes a plurality of light-receiving elements; and
wherein the light-emitting elements and the light-receiving elements are opposed to each other while being positioned on inner edges of the frame-shaped plate.

15. The underlay-board-equipped input device according to claim 8,
wherein the light-emitting means includes a plurality of light-emitting elements;
wherein the light-receiving means includes a plurality of light-receiving elements; and
wherein the light-emitting elements and the light-receiving elements are opposed to each other while being positioned on inner edges of the frame-shaped plate.

16. The underlay-board-equipped input device according to claim 7,
wherein the light-emitting means and the light-receiving means include two modules disposed on respective corners lying on opposite ends of one side of the frame-shaped plate, each of the two modules including a light-emitting element and a light-receiving element which are stacked vertically;
wherein a retroreflector in the form of a tape is affixed to inner side surface of three sides other than the one side lying between the modules; and
wherein light beams projected from the light-emitting element of one of the modules are reflected from the retroreflector and are then received by the light-receiving element of the one module.

17. The underlay-board-equipped input device according to claim 8,
wherein the light-emitting means and the light-receiving means include two modules disposed on respective corners lying on opposite ends of one side of the frame-shaped plate, each of the two modules including a light-emitting element and a light-receiving element which are stacked vertically;
wherein a retroreflector in the form of a tape is affixed to inner side surface of three sides other than the one side lying between the modules; and
wherein light beams projected from the light-emitting element of one of the modules are reflected from the retroreflector and are then received by the light-receiving element of the one module.
